(19) United States
(12) Patent Application Publication
(10) Pub. No.: US 2009/0091268 A1
(43) Pub. Date: Apr. 9, 2009

(54) AIRFIELD LIGHTING WITH LED

(75) Inventors: Johan FORSSEN, Froson (SE); Ola Hakanson, Froson (SE)

Correspondence Address: BLANK ROME LLP, WATERGATE, 600 NEW HAMPSHIRE AVENUE, N.W., WASHINGTON, DC, 20037, US

(73) Assignee: SAFEGATE INTERNATIONAL AB, Malmo (SE)

(21) Appl. No.: 12/240,471

(22) Filed: Sep. 29, 2008

Related U.S. Application Data
(60) Provisional application No. 60/978,443, filed on Oct. 9, 2007.

(30) Foreign Application Priority Data
Oct. 9, 2007 (EP) 07118111.9

(51) Int. Cl. H05B 41/30

(52) U.S. Cl. 315/250; 315/246

(57) ABSTRACT

A method of feeding electric power to an LED (4) in an airfield lighting unit (7). The method comprises the steps of: feeding a constant alternating current (Iₛ) to a rectifier (40), rectifying the alternating current (Iₛ) to a rectified current (Iᵣ), pulse width modulating the rectified current (Iᵣ), charging a capacitor (43) with the pulse width modulated rectified current (Iᵣ), and feeding the LED (4) with power from the capacitor (43).

### TECHNICAL FIELD

The present invention relates to a method, a unit and a system for feeding power to LED airfield lighting.

### BACKGROUND ART

At airports, lighting systems are used for directing airplanes during landing and taxiing. These lighting systems have a large number of light sources and it is important they are operated properly and that failed light sources are replaced quickly, especially during times of low visibility. Otherwise, the consequences of a plane missing a taxiway or a stop signal can be disastrous. Since visual light source inspection increases the risk for an accident and induce costs, automatic lamp monitoring systems have been developed.

Light sources in these lighting systems are frequently connected into a so-called series circuit using an isolation transformer for each light source.

Such light sources are connected in series via a power cable and fed by a constant current power supply from a constant current regulator (CCR). Traditionally, conventional lamps are been used as light sources, but as the price of light emitting diodes (LEDs) decrease, LEDs are becoming more common. Since LEDs usually must be supplied with a different electrical current than traditional lams, new power supplies are needed.

US 2005/0030192, for example, discloses a power supply for LED airfield lighting and includes a regulated power supply with a power input, an LED control signal input, and a power output. The power input is configured to be connected to a power source, the LED control signal input is configured to receive an LED control signal, the power output is configured to supply an LED drive current to one or more of the LEDs, and the regulated power supply is configured to adjust the LED drive current based upon the LED control signal. The regulated power supply also includes a processor having a current sense input and an LED control signal output connected to the LED control signal input of the regulated power supply. The current sense input is configured to receive a signal corresponding to an airfield current step. The processor is programmed to determine the LED control signal based upon the current sense input signal. The LED control signal is determined so as to enable the LEDs to have a relative intensity approximately equal to relative intensity of an incandescent light source driven at the airfield current step.

Present solutions for supplying power to an airfield LED lighting unit are often rather complex and expensive. Another problem is that LEDs do not have the same load characteristics as lamps, which results in a more unstable load for the airfield current step, or the constant current regulator.

### SUMMARY OF THE INVENTION

It is an object of the present invention to provide an improvement of the above techniques and prior art.

A particular object is to provide cost-efficient way of feeding of electric power to an LED in an airfield lighting application.

These and other objects as well as advantages that will be apparent from the following description of the present invention are achieved by a method, an airfield lighting unit and an airfield lighting system according to the respective independent claims. Preferred embodiments are defined in the dependent claims.

Hence a method is provided of feeding electric power to an LED in an airfield lighting unit, said method comprising the steps of: feeding a constant alternating current to a rectifier, rectifying the alternating current to a rectified current, pulse width modulating the rectified current, charging a capacitor with the pulse width modulated rectified current, and feeding the LED with power from the capacitor.

The inventive method is advantageous in that it ensures a stable load for the feeding of the alternating electrical current. This means that the risk of instable operation of a constant current regulator that provides the current is reduced. In brief, the stable load is achieved by creating a more resistive characteristic of the load, i.e. imitating the load characteristics of a lamp with a power factor close to one, even though the LED needs a rectified current. Moreover, the solution is rather simple and offers a cost efficient implementation.

The step of pulse width modulating the rectified current may include determining the duty cycle of the pulse width modulated rectified current in dependence of any of the constant alternating current and the rectified current.

In said determining of the duty cycle, said duty cycle may be determined proportional to the instantaneous value of any of the constant alternating current and the rectified current.

The step of pulse width modulating the rectified current may include determining the duty cycle of the pulse width modulated rectified current in dependence of a voltage across the capacitor.

In said determining of the duty cycle, said duty cycle may be increased if the voltage across the capacitor is below a voltage reference value, and said duty cycle may be decreased if the voltage across the capacitor is above the voltage reference value. This means that increased charging of the capacitor is achieved if the feeding of power to the LED is increased, and vice versa.

The step of pulse width modulating the rectified current may include the step of determining the duty cycle of the pulse width modulated rectified current in dependence of how much time has passed since the charging of the capacitor begun.

In said determining of the duty cycle, said duty cycle may be gradually increased until a predetermined time has passed since the charging of the capacitor begun. This results in decreased capacitive characteristic during the initial charging of the capacitor.

The step of feeding the LED with power from the capacitor may be started only when a control unit for pulse width modulating the rectified current is operable.

The step of feeding the LED with power from the capacitor may include pulse width modulating the current running from the capacitor to the LED.

The inventive method may further comprise the step of monitoring any of a voltage across the LED and a current through the LED.

The step of monitoring any of a voltage across the LED and a current through the LED may further comprise the step of sending, superimposed on said constant alternating current, a signal representative of any of the monitored voltage across the LED and the current through the LED. This is advantageous in that a malfunctioning LED may be detected.

The inventive method may further comprise the step of sending, superimposed on said constant alternating current, a signal for controlling any of an on status, an off status and a light intensity of the LED.

According to another aspect of the invention, an airfield lighting unit is provided comprising a rectifier with a constant alternating current input, the rectifier being configured to alternate a constant alternating current to a rectified current, a pulse width modulator connected to the rectifier and modulating the rectified current, a capacitor connected to the pulse width modulator and being charged by the modulated rectified current, and an LED connected to and supplied by electric power from the capacitor.

The inventive airfield lighting unit may comprise any of the features described above in association with the inventive method, and has corresponding advantages.

According to yet another aspect of the invention, an airfield lighting system is provided, comprising a plurality of the inventive airfield lighting units connected in series to a constant current regulator.

As known within the art, a duty cycle is defined as the ratio between the duration that the current is non-zero and the period of a waveform of the current. It should be noted that the current must not necessarily have a square waveform.

### BRIEF DESCRIPTION OF THE DRAWINGS

Embodiments of the present invention will now be described, by way of example, with reference to the accompanying schematic drawings, in which

FIG. 1 is a schematic view of an airfield lighting system, and

FIG. 2 is a schematic view of an airfield lighting unit.

### DETAILED DESCRIPTION OF PREFERRED EMBODIMENTS OF THE INVENTION

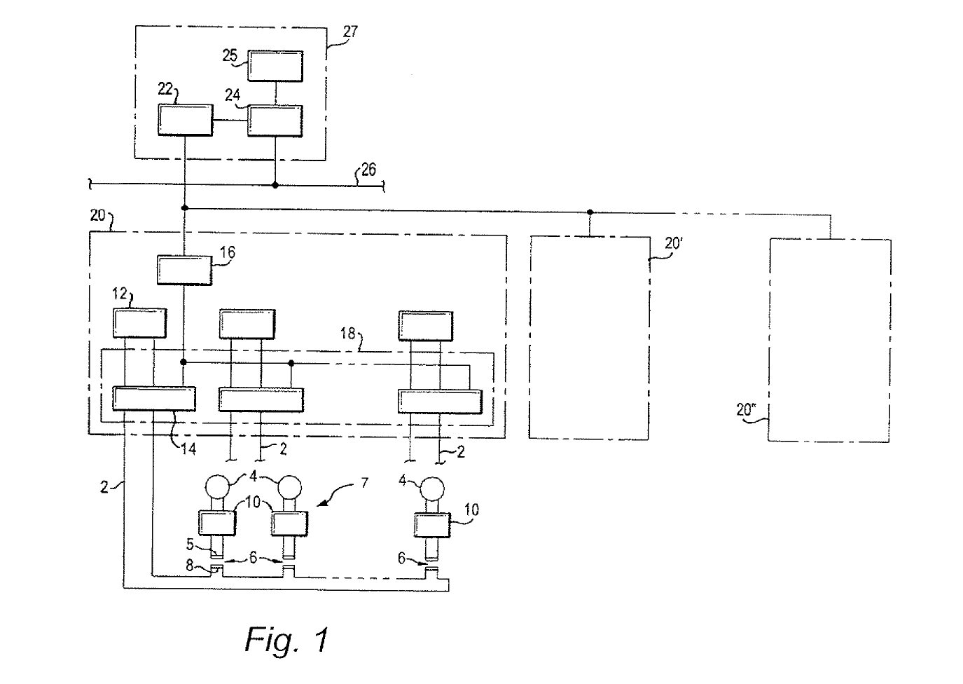

With reference to FIG. 1, an airfield lighting monitoring system includes a number of current supply loops 2 for LEDs 4, only one of said loops 2 being shown in its entirety in the Figure. Each LED 4 is connected to its associated loop 2 via a secondary winding 5 of an isolation transformer 6, the primary winding 8 of which is series connected in the current supply loop, and via a light monitor switch (LMS) 10. Each current supply loop 2 is fed by a constant current regulator (CCR) 12 via a communicating Series Circuit Modem (SCM) 14. A concentrator unit (CU) 16 is connected in a serial or network communication configuration to a group 18 of the communicating units 14.

The CU unit 16 and its associated elements, described above, together form a sub-unit 20, which can e.g. be devoted to a certain part of the lighting system of an airfield. The lighting system can include a required number of similar sub-units, of which some are indicated at 20′ and 20″.

The CU units 16 in said sub-units are connected to a central concentrator unit 22 via serial communication or network.

The central CU unit 22 can be connected to a computer 24 with a display 25. The computer 24 can be further connected to other systems via, for example, a local area network (LAN) 26. The unit 22 and computer 24 can e.g. be localized in a control room 27, or at some other suitable place.

An SCM unit 14 detects responses from the LMS modules and reports the addresses of nonresponding modules via the local CU unit 16 to the central concentrator unit 22. In the central concentrator unit 22, the addresses are stored in a database accessible to the computer 24 in the control room 27.

On the display 25 the status of LEDs 4, such as the light intensity and on/off status, and the position of each LED can be displayed. Different alarm criteria can be set in the central concentrator unit 22 via the computer 24.

The communication between the LMS modules and the associated communicating unit is carried out by high frequency signals superimposed on the 50 Hz or 60 Hz current in the power cable.

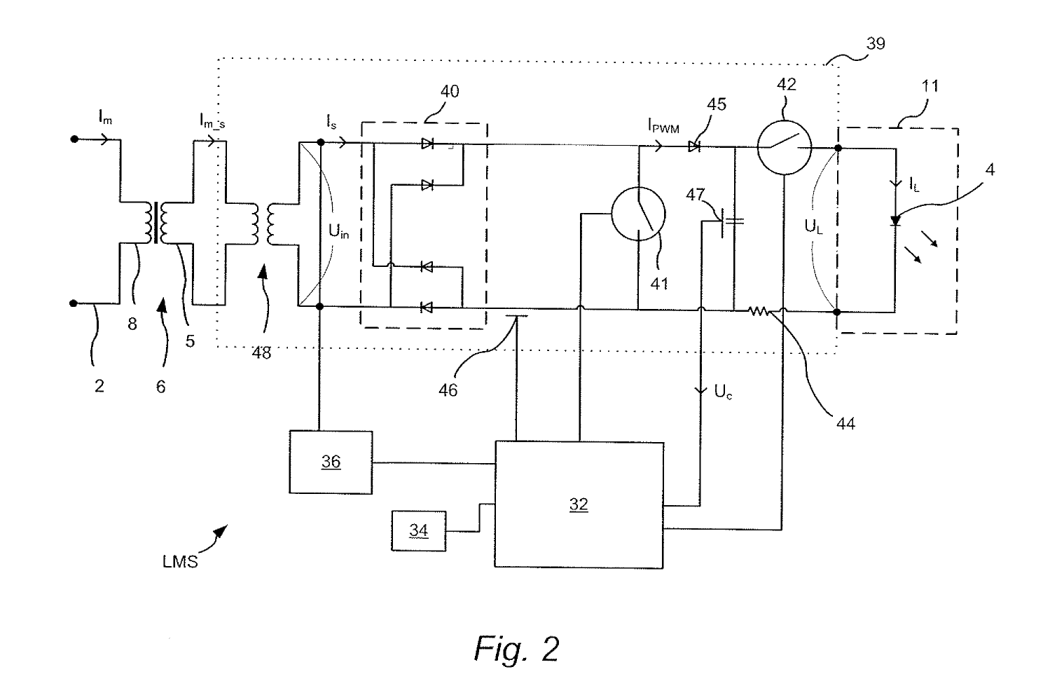

With reference to FIG. 2, an airfield lighting unit 7 is illustrated and includes a LMS module 10 with a connected LED 4 into circuit with the secondary winding 5 of the isolation transformer 6. The LMS includes a converter 39 that comprises a transformer 48 and a conventional rectifier 40.

The isolation transformer 6 transforms in a known manner the alternating current Iₘ supplied by the constant current regulator 12 to a secondary main current Iₘ_{_{—}}ₛ that is fed to the transformer 48. The transformer 48 scales down the secondary main current Iₘ_{_{—}}ₛ to a secondary current Iₛ that is fed to the rectifier 40, which in turn converts the alternating, secondary current Iₛ to a rectified current Iᵣ. The scaling ratio is selected according to the power needs of the LMS module 10 and the LED 4.

The rectifier 40 is connected to a capacitor 43 via a pulse width modulator 41 that modulates the rectified current Iᵣ and supplies the pulse width modulated current I_{PWM} to a capacitor 43. The capacitor 43 is in turn connected to a load 11 in the form of the LED 4, via a second pulse width modulator 42 that modulates a load current I_{L} that flows from the capacitor 43 to the load 11. Between the first pulse width modulator 41 and the capacitor 43 is a diode 45 arranged for assuring that the current from the capacitor 43 may not flow from the capacitor 43 to the first pulse width modulator 41, but only to the second pulse with modulator 42 and subsequently to the load 11.

The second pulse width modulator 42 is connected in series with the load 11 and a resistor 44. The first pulse width modulator 41 is connected in parallel with the capacitor 43, between the rectifier 40 and the capacitor 43. Both pulse width modulators 41, 42 are controlled in a conventional manner by a control unit 32 that incorporates a microprocessor. In brief, each modulator 41, 42 is a simple switch that is opened or closed in dependence of how long duty cycle is desired, i.e. a longer closing of the switch in the first modulator 41 results in a shorter duty cycle of the I_{PWM} current, while a longer closing of the switch in the second modulator 42 results in a longer duty cycle of the I_{L} current.

Current sensor means 46 are arranged to sense the rectified current Iᵣ and send a signal representing the instantaneous value of the rectified current Iᵣ to the control unit 32. Voltage sensing means 47 are arranged to sense a voltage U_{c} across the capacitor 43 and send a signal representing this voltage to the control unit 32.

Moreover a receiver 36 is connected for receiving a signal from the SCM unit 14 and forwarding it to the control unit 32. Typical signals represent desired light intensity of the LED, on status and off status of the LED. The LMS module 10 also contains a dc power supply unit (not shown) for the control unit 32 and the receiver 36. An address memory 34 is also connected to the control unit 32 for storing data associated with the unique air field lighting unit 7 in question. The receiver 36 and the address memory 34 communicates with the SCM unit 14 and the control unit 32 in a manner known within the art.

When the air field lighting unit 7 is to be operated the control unit 32 must be started up. Before the control unit 32 is powered up and fully operable, the switch 41 is closed or generates a minimal pulse width modulated duty cycle for the I_{PWM} current. When the control unit 32 is operable the first pulse width modulator 41 is operated by the control unit 32 so that the duty cycle depends of the instantaneous value of the rectified current Iᵣ, the voltage across the capacitor U_{c}, and how long time has passed since the charging of the capacitor 43 begun. This means that the control unit 32 is also configured to monitor how long time has passed since the charging of the capacitor 43 begun, i.e. monitor how long time has passed since the start of the operation of the first pulse width modulator 41.

In more detail, a higher instantaneous value of the rectified current Iᵣ results in a longer duty cycle, and vice versa. A voltage across the capacitor U_{c} that is below a voltage reference value results in a longer duty cycle, while a voltage across the capacitor U_{c} that is above the voltage reference value results in a shorter duty cycle. A short time lap since the charging of the capacitor 43 begun results in a gradually longer duty cycle, to minimize capacitive characteristics, while a long time lap does not effect the duty cycle at all.

In other words, the duty cycle of the I_{PWM} current is determined by using the following parameters as an input: the rectified current Iᵣ, the voltage across the capacitor U_{c} and a value representing how much has passed since the charging of the capacitor 43 begun.

The proportion between the instantaneous value of the rectified current Iᵣ, the capacitor voltage reference value, and the time lap discussed above, are each empirically and/or theoretically established, and depend of course on type of capacitor, LED, etc.

By modifying the duty cycle of the load current I_{L}, a preferred light intensity of the LED may be achieved. In brief, a long duty cycle of I_{L} results in a higher light intensity of the LED 4, while a relatively shorter duty cycle of I_{L} results in a relatively lower light intensity of the LED, i.e. the LED light intensity is proportional to the duty cycle of the load current I_{L}.

When the LED emits light, the overall duty cycle of the load current I_{L} has such a high frequency that the human eye does not detect any flickering of the LED 4.

The control unit 32 also monitors the voltage across the LED and the current through the LED for purpose of detecting malfunction of the LED. The voltage is compared with a voltage reference value and the current with a current reference value, and if any of the measured values deviates to much from the its corresponding reference value, the LMS 10 sends a signal indicative of malfunction of the LED, via the SCM 14 and the CU 16 to the central concentrator unit 22. Of course, a signal representing the voltage across the LED and the current through the LED may be transferred to the central concentrator unit 22 for subsequent determination if the voltage/current value deviates from a reference value.

It should be noted that pulse width modulation per se is part of prior art. The same applies for current rectification, transformation as well as measurement of current and voltage.

1: A method for feeding electric power to an LED (4) in an airfield lighting unit (7), said method comprising the steps of:
feeding a constant alternating current (Iₛ) to a rectifier (40),
rectifying the alternating current (Iₛ) to a rectified current (Iᵣ),
pulse width modulating the rectified current (Iᵣ),
charging a capacitor (43) with the pulse width modulated rectified current (Iᵣ), and
feeding the LED (4) with power from the capacitor (43).

2: The method according to claim 1, wherein the step of pulse width modulating the rectified current (Iᵣ) includes:
determining the duty cycle of the pulse width modulated rectified current (Iᵣ) in dependence of any of the constant alternating (Iₛ) current and the rectified current (Iᵣ).

3: The method according to claim 2, wherein said duty cycle is determined proportional to the instantaneous value of any of the constant alternating current (Iₛ) and the rectified current (Iᵣ).

4: The method according to claim 1, wherein the step of pulse width modulating the rectified current (Iᵣ) includes:
determining the duty cycle of the pulse width modulated rectified current (Iᵣ) in dependence of a voltage across the capacitor (U_{c}).

5: The method according to claim 4, wherein, in said determining of the duty cycle, said duty cycle is increased if the voltage across the capacitor (U_{c}) is below a voltage reference value, and wherein said duty cycle is decreased if the voltage across the capacitor (U_{c}) is above the voltage reference value.

6: The method according to claim 1, wherein the step of pulse width modulating the rectified current (Iᵣ) includes:
determining the duty cycle of the pulse width modulated rectified current (Iᵣ) in dependence of how much time has passed since the charging of the capacitor (43) begun.

7: The method according to claim 6, wherein, in said determining of the duty cycle, said duty cycle is gradually increased until a predetermined time has passed since the charging of the capacitor (42) begun.

8: The method according to claim 1, wherein the step of feeding the LED (4) with power from the capacitor (43) only starts when a control unit (32) for pulse width modulating the rectified current is operable.

9: The method according to claim 1, wherein the step of feeding the LED (4) with power from the capacitor (43) includes pulse width modulating the current (I_{L}) running from the capacitor (43) to the LED (4).

10: The method according claim 1, further comprising the step of monitoring any of a voltage across the LED (U_{L}) and a current through the LED (I_{L}).

11: The method according to claim 10, further comprising the step of sending, superimposed on said constant alternating current (Iₛ), a signal representative of any of the monitored voltage across the LED (U_{L}) and the current through the LED (I_{L}).

12: The method according to claim 1, further comprising the step of sending, superimposed on said constant alternating current (Iₛ), a signal for controlling any of an on or and off status and a light intensity of the LED (4).

13: An airfield lighting unit comprising
a rectifier (40) with a constant alternating current input, the rectifier (40) being configured to alternate a constant alternating current (Iₛ) to a rectified current (Iᵣ),
a pulse width modulator (41) connected to the rectifier (40) and modulating the rectified current (Iᵣ),
a capacitor (43) connected to the pulse width modulator (41) and being charged by the modulated rectified current (I_{PWM}), and
an LED (4) connected to and supplied by electric power from the capacitor (43).

14: The airfield lighting unit according to claim 13, wherein the pulse width modulator (41) is configured to determine the duty cycle of the pulse width modulated rectified current (Iᵣ) in dependence of any of the constant alternating current (Iₛ) and the rectified current (Iᵣ).

15: The airfield lighting unit according to claim 14, wherein said duty cycle is proportional to the instantaneous value of any of the constant alternating current (Iₛ) and the rectified current (Iᵣ).

16: The airfield lighting unit according to claim 13, wherein the pulse width modulator (41) is configured to determine the duty cycle of the pulse width modulated rectified current (Ir) in dependence of a voltage across the capacitor (Uc).

17: The airfield lighting unit according to claim 16, wherein said duty cycle is increased if the voltage across the capacitor (U_{c}) is below a voltage reference value, and wherein said duty cycle is decreased if the voltage across the capacitor (U_{c}) is above the voltage reference value.

18: The airfield lighting unit according to claim 13, wherein the pulse width modulator (41) is configured to determine the duty cycle of the pulse width modulated rectified current (Iᵣ) in dependence of how much time has passed since the charging of the capacitor (43) begun.

19: The airfield lighting unit according to claim 18, wherein said duty cycle is gradually increased until a predetermined time has passed since the charging of the capacitor (43) begun.

20: The airfield lighting unit according to claim 13, wherein the capacitor (43) is prevented from feeding power to the LED until a control unit (32) for pulse width modulating the rectified current (Iᵣ) is operable.

21: The airfield lighting unit according to claim 13, further comprising a second pulse width modulator (42) configured to pulse width modulate the current running from the capacitor to the LED (I_{L}).

22: The airfield lighting unit according to claim 13, further comprising means for monitoring any of a voltage across the LED (U_{L}) and a current through the LED (I_{L}).

23: The airfield lighting unit according to claim 22, further comprising a receiver (36) configured to send, superimposed on said constant alternating current (Iₛ), a signal representative of any of the monitored voltage across the LED (U_{L}) and the current through the LED (I_{L}).

24: The airfield lighting unit according to claim 13, further comprising a receiver (36) configured to send, superimposed on said constant alternating current (Iₛ), a signal controlling any of an on or off status and a light intensity of the LED (4).

25: An airfield lighting system comprising a plurality of airfield lighting units according to claim 13, said airfield lighting units being connected in series to a constant current regulator (12).
